(19) United States
(12) Patent Application Publication
(10) Pub. No.: US 2012/0062910 A1
(43) Pub. Date: Mar. 15, 2012

(54) PRINT DATA TRANSFORMATION USING CONVERSION ARRAYS

(76) Inventors: Randell Rivadeneira, Broomfield, CO (US); Natalie Dawn Ross, Longmont, CO (US)

(21) Appl. No.: 12/878,566

(22) Filed: Sep. 9, 2010

(51) Int. Cl. G06F 15/00

(52) U.S. Cl. 358/1.9

(57) ABSTRACT

Methods and systems are disclosed herein for print data transformation using conversion arrays. A print datastream is received, where the print datastream includes bitmap data encoded as a first number of bits per pel. An array of conversion values is retrieved to convert the bitmap data to a second number of bits per pel encoding. The bitmap data is then converted using the array to the second number of bits per pel encoding, where one or more bytes of the bitmap data is used as an index to the array to generate output data. A printed output is generated based on the output data.

### FIELD OF THE INVENTION

The invention relates to the field of printing systems and, in particular, to print data transformation from a first bit per pel encoding to a second bit per pel encoding using conversion arrays.

### BACKGROUND

Print datastreams may include different types of data that are converted by a printer prior to printing the data. For example, a print datastream may include a combination of Page Description Language (PDL) data and bitmap data. The PDL data is typically sent to a rasterizer for converting the PDL data into a raster image, or bitmap, prior to printing the PDL data. Bitmap data within the print datastream is encoded as a number of bits per pel (or bits per pixel), which may then be converted to a different number of bits per pel prior to printing the bitmap data. The bitmap data may, for example, be encoded as 1, 2, 4, or 12 bits per pel, while 8 or 16 bit processing per pel data may be desired. Therefore, the bitmap data is converted from the 1, 2, 4, or 12 bits per format pel to an 8 bit per pel format or a 16 bit per pel format prior to processing. This conversion is expensive computationally for the printer in that it uses processing capabilities that may be used for other printing functions. Therefore, a need exists for improving the performance of print data conversion in the printer.

### SUMMARY

Embodiments described herein provide systems and methods for print data transformation using conversion arrays in a manner that is less computationally intensive. A print datastream is received, where the print datastream includes bitmap data having a first number of bits per pel encoding. An array of conversion values is retrieved to convert the bitmap data to a second number of bits per pel encoding. The bitmap data is then converted using the array to the second number of bits per pel encoding, where one or more bytes of the bitmap data is used as an index to the array to generate the output data. A printed output is then generated based on the output data.

In one embodiment, a printer comprising a print controller and a print engine is disclosed for print data transformation using conversion arrays. The print controller is operable to receive a print datastream, where the print datastream includes bitmap data having a first number of bits per pel encoding. The print controller is further operable to retrieve an array of conversion values to convert the bitmap data to a second number of bits per pel encoding, and to convert the bitmap data to the second number of bits per pel encoding using the array, where one or more bytes of the bitmap data is used as an index to the array to generate output data. The print engine is operable to generate a printed output based on the output data.

In another embodiment, a method is disclosed of print data transformation using conversion arrays. According to the method, a print datastream is received, where the print datastream includes bitmap data encoded as a first number of bits per pel. An array of conversion values is retrieved to convert the bitmap data to a second number of bits per pel encoding. The bitmap data is then converted to the second number of bits per pel encoding using the array, where one or more bytes of the bitmap data is used as an index to the array to generate output data. Further according to the method, a printed output is generated based on the output data.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 is a block diagram illustrating a printing system for print datastream transformation using conversion arrays in an exemplary embodiment.

FIG. 2 is a flow chart illustrating a method of print datastream transformation using conversion arrays in an exemplary embodiment.

FIG. 3 illustrates a computer system operable to execute computer readable medium embodying programmed instructions to perform desired functions in an exemplary embodiment.

### DESCRIPTION OF THE EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

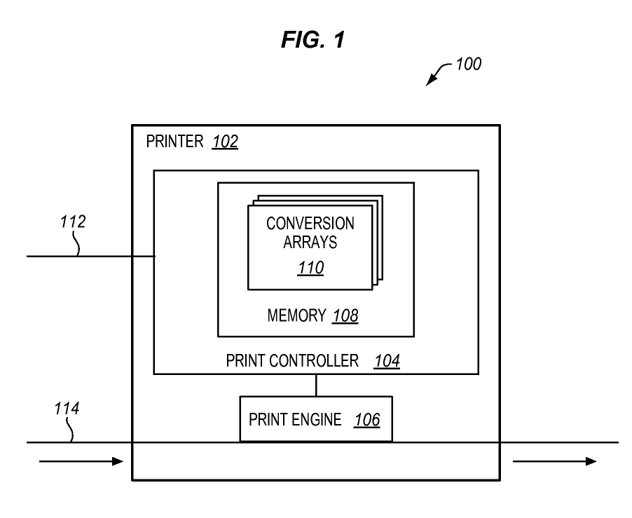

FIG. 1 is a block diagram illustrating a printing system 100 for print datastream 112 transformation using conversion arrays 110 in an exemplary embodiment. Printer 102 includes a print controller 104, and a print engine 106. Print controller 104 comprises any device, component, or system operable to receive print datastream 112, and to convert print datastream 112 into a data format suitable for printing onto a media 114 by print engine 106. Print datastream 112 may include, for example, data in a number of bitmap formats and Page Description Language (PDL) formats. Examples of bitmap data formats include Joint Photographic Experts Group (JPEG), Tagged Image File Format (TIFF), Graphics Interchange Format (GIF), etc. Examples of PDL data formats include Advanced Function Presentation (AFP), Intelligent Printer Data Stream (IPDS), Mixed Object Document Control Architecture (MODCA), etc. In printing system 100, media 114 is fed through printer 102 in the direction indicated by the arrow for imprinting by print engine 106. In this regard, print engine 106 includes any device, component, or system operable to generate a printed output onto media 114. Print controller 104 includes a memory 108 storing one or more conversion arrays 110. Conversion arrays 110 comprise an array of values for converting the bitmap data in print datastream 112 from a first number of input bits per pel encoding to a second number of output bits per pel encoding. Typically, the pels used to represent the bitmap data in print datastream 112 are encoded as a number of bits per pel. For example, the bitmap data may be encoded as 2, 4, 6, 8, 12, 16, 18, etc., bits per pel. However, print controller 104 may be configured to convert the bitmap data to a different number of bits per pel encoding during the printing process, such as converting the bitmap data to 8 or 16 bits per pel encoding. The converted bitmap data may then be processed prior to the bitmap data. In system 100, printer 102 uses one or more conversion arrays 110 to perform the bitmap data conversion in a more efficient manner.

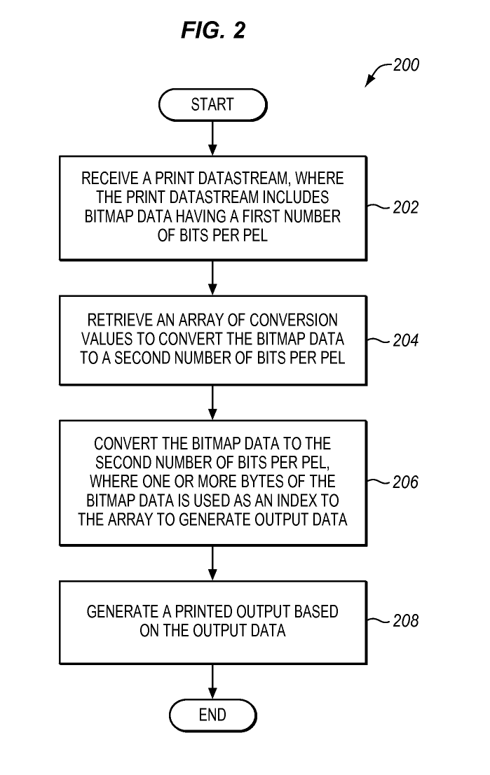

FIG. 2 is a flow chart illustrating a method 200 of print datastream 112 transformation using conversion arrays 110 in an exemplary embodiment. The steps of method 200 will be described with respect to system 100 of FIG. 1, although one skilled in the art will recognize that method 200 may be performed by other systems not shown. In addition, the steps of the flow charts shown herein are not all inclusive and other steps, not shown, maybe included. Further, the steps may be performed in an alternate order.

In step 202, print controller 104 (see FIG. 1) receives print datastream 112. Print datastream 112 includes bitmap data (not shown) having a first number of bits per pel encoding. Print datastream 112 may include a number of different sections of bitmap data, where some sections of the bitmap data are encoded using a different number of bits per pel than other sections of the bitmap data. For example, a first section of the bitmap data in print datastream 112 may be encoded as 2 bits per pel, while a second section of bitmap data in print datastream 112 may be encoded as 4 bits per pel. Thus, print controller 104 may be configured to convert a variety of different bits per pel encodings when converting print datastream 112.

In step 204, print controller 104 retrieves one or more conversion arrays 110 for converting the bitmap data to a second number of bits per pel encoding. Some sections of the bitmap data may be converted to a different number of output bits per pel encoding than other sections of the bitmap data. For example, some sections of the bitmap data may be converted to an output of 8 bits per pel encoding while other sections of the bitmap data may be converted to an output of 16 bits per pel encoding. Conversion arrays 110 may be retrieved based on identifying the first number of bits per pel encoding of the bitmap data to be converted, and identifying a desired second number of bits per pel encoding for the output of the conversion. In some embodiments, conversion arrays 110 may have a dimension such as 2, 4, 6, etc., as a matter of design choice.

In step 206, print controller 104 converts the bitmap data to the second number of bits per pel encoding, where one or more bytes of the bitmap data is used as an index to the array to generate output data. Because conversion arrays 110 are arrays of conversion values, an index to the array is an index to a set of conversion values based on the index. Thus, conversion arrays 110 map the first number of bits per pel encoding of the bitmap data to the second number of bits per pel encoding to generate the output. In one embodiment, a size in bytes of the index to arrays 110 may be selected as a matter of design choice. For example, the number of bytes might be chosen based on performance or memory requirements for implementing arrays 110. The number of bits in the array index is then (the number of bytes)*8. As discussed previously, arrays 110 are used to convert from a first number of bits per pel to a second number of bits per pel. Thus, the index to arrays 110 include at least one pel in the input space for arrays 110 to be used for conversion. In other words, this indicates that it is desirable that the number of bits in the index is greater than or equal to the first number of bits per pel. The number of pels included in the index is generally equal to the mathematical floor operator of: (the number of bits in the index)/(the first number of bits per pel), where the number of bits in the array index is greater than or equal to the first number of bits per pel, and divisible by 8. A floor operator maps a number to the largest previous integer such that floor(x)=└x┘ and is the smallest integer not less than x. For example, └2.4┘=2, └2.7┘=2, and └3.1┘=3, etc. Arrays 110 are then used to map the index to a number of output pels, where each output pel is encoded with the second number of bits per pel. For example, consider that the bitmap data is encoded as 2 bits per pel and an output encoding of 8 bits per pel is desired. Thus, the number of pels included in the index using the floor operator would be └8/2┘, or 4 pels. Further, the size in bytes of the output value for each array entry is generally (the number of input pels in the index)*(the second number of bits per pel/8), where the second number of bits per pel is greater than or equal to 8, and the second number of bits per pel≡0 (modulus 8). In continuing with the example above for 2 bits per pel of input data and a desired output encoding of 8 bits per pel of output data, this corresponds to: (4*8)/8, which is 4 bytes of generated output per byte of bitmap data input. This naturally follows as each of the pels is converted from 2 bits per pel of input data to 8 bits per pel of output data.

In another embodiment, the size of the index to arrays 110 may be selected such that the index includes a minimum number of bytes that will also include at least one pel in the input space. In this case, the size of the array index may then be calculated as the mathematical ceiling operator of: (the first number of bits per pel/8). A ceiling operator maps a number to the smallest following integer such that ceiling(x)=┌x┐ and is the smallest integer not less than x. For example, ┌2.4┐=3, ┌2.7┐=3, and ┌3.1┐=4, etc. In continuing with the example above for 2 bits per pel encoding of bitmap data, this corresponds to: ┌2/8┐ or a 1 byte index. In the example, this indicates that each byte of bitmap data in print datastream 112 is used as an index to the retrieved arrays 110. Further, in this embodiment the number of pels in the index is generally determined as ((a number of bytes of the index*8)/the first number of bits per pel), or in the example (1*8/2)=4 pels per index. This naturally follows as each pel is 2 bits and the index size is 1 byte, or 8 bits.

In step 208, print engine 106 (see FIG. 1) prints the data based on the generated output of step 206.

### Example

Consider the following example for 2 bits per pel of input bitmap data converted to 8 bits per pel of output using the following 2-dimensional conversion array:

TABLE 1

| Conversion values | | | | Index |
|---|---|---|---|---|
| 0 × 00 | 0 × 00 | 0 × 00 | 0 × 00 | 0 × 00 |
| 0 × 00 | 0 × 00 | 0 × 00 | 0 × 55 | 0 × 01 |
| 0 × 00 | 0 × 00 | 0 × 00 | 0 × AA | 0 × 02 |
| 0 × 00 | 0 × 00 | 0 × 00 | 0 × FF | 0 × 03 |
| 0 × 00 | 0 × 00 | 0 × 55 | 0 × 00 | 0 × 04 |
| 0 × 00 | 0 × 00 | 0 × 55 | 0 × 55 | 0 × 05 |
| 0 × 00 | 0 × 00 | 0 × 55 | 0 × AA | 0 × 06 |
| 0 × 00 | 0 × 00 | 0 × 55 | 0 × FF | 0 × 07 |
| 0 × 00 | 0 × 00 | 0 × AA | 0 × 00 | 0 × 08 |
| . . . | . . . | . . . | . . . | . . . |
| 0 × FF | 0 × FF | 0 × FF | 0 × FF | 0 × FF |

Table 1 represents a 2-dimensional array of conversion values for converting bitmap data from 2 bits per pel to 8 bits per pel. Thus, in this example, each pel of bitmap data to be converted is encoded as 2 bits per pel and each byte of bitmap data encodes 4 pels (2 bits per pel into 8 bits per byte is 4 pels). Consider the following 3 bytes of bitmap data for conversion from 2 bits per pel into 8 bits per pel:

0x00, 0x02, 0xFF.

As discussed above, the number of bytes of the index to the conversion array in one embodiment may generally be determined as ┌the first number of bits per pel/8┐, or ┌2/8┐=1. In the example, this corresponds to a 1-byte index. Thus, each byte of the bitmap data to be converted represents an index to the array of table 1. However, in other embodiments, 2, 3, 4, etc., bytes may be used as the index, which may modify the number of pels in the index and the number of bytes in the output as discussed previously. In continuing with the example, the value of 0x00 of input bitmap data has an output index 0x00 of table 1, or 0x00 0x00 0x00 0x00, 0x02=0x00 0x00 0x00 0xAA, and 0xFF=0xFF 0xFF 0xFF 0xFF. Converting bitmap data using conversion arrays such as table 1 allows for a fast and efficient mechanism for data transformation in the printer.

Although the example above illustrates the conversion of 2 bits per pel of input bitmap data to 8 bits per pel of output data, one skilled in the art will understand that other conversion arrays for converting input bitmap data to output bitmap data exist. For example, conversion arrays may be used to convert 2, 4, 6, 8, 10, 12, 14, 16, etc., bits per pel input data to 8, 16, 24, etc., bits per pel output data.

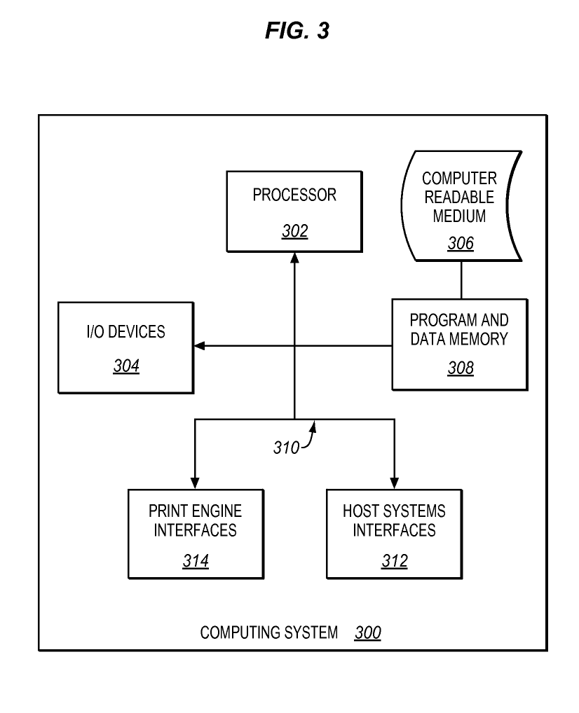

The invention can take the form of an entirely hardware embodiment, an entirely software embodiment or an embodiment containing both hardware and software elements. In one embodiment, the invention is implemented in software, which includes but is not limited to firmware, resident software, microcode, etc. FIG. 3 illustrates a computing system 300 in which a computer readable medium 306 may provide instructions for performing method 200 in an exemplary embodiment.

Furthermore, the invention can take the form of a computer program product accessible from a computer-usable or computer-readable medium 306 providing program code for use by or in connection with computing system 300. For the purposes of this description, a computer-usable or computer readable medium 306 can be any apparatus that can contain, store, communicate, or transport the program for use by computing system 300.

The medium 306 can be an electronic, magnetic, optical, electromagnetic, infrared, or semiconductor system (or apparatus or device) or a propagation medium. Examples of a computer-readable medium 306 include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code generally will include a processor 302 coupled with memory 308 through a system bus 310. The memory 308 can include local memory employed during actual execution of the program code, bulk storage, and cache memories which provide temporary storage of at least some program code in order to reduce the number of times code is retrieved from bulk storage during execution.

Input/output devices 304 (including but not limited to keyboards, displays, pointing devices, etc.) can be coupled to the system either directly or through intervening I/O controllers.

Network adapters may also be coupled to the system to enable the data processing system to become coupled to other data processing systems, such a through host systems interfaces 312, or remote printers or storage devices through intervening private or public networks, such as through print engine interfaces 314. Modems, cable modem and Ethernet cards are just a few of the currently available types of network adapters.

Although specific embodiments were described herein, the scope of the invention is not limited to those specific embodiments. The scope of the invention is defined by the following claims and any equivalents thereof.

We claim:

1. A printer comprising:
a print controller operable to receive a print datastream, wherein the print datastream includes bitmap data having a first number of bits per pel, the print controller being further operable to retrieve an array of conversion values used to convert the bitmap data to a second number of bits per pel, and to convert the bitmap data to the second number of bits per pel using the array, wherein one or more bytes of the bitmap data is used as an index to the array to generate output data; and
a print engine operable to generate a printed output based on the output data.

2. The printer of claim 1 wherein a number of bytes of the index to the array is generally determined according to the following equation:
a mathematical ceiling operator of (the first number of bits per pel/8).

3. The printer of claim 2 wherein a number of pels in the index to the array is generally determined according to the following equation:
((a number of bytes of the index to the array*8)/the first number of bits per pel).

4. The printer of claim 3 wherein a number of bytes of the output is generally determined according to the following equation:
(the number of pels in the index to the array*the second number of bits per pel)/8,
wherein the second number of bits per pel is >=8 and the second number of bits per pel≡0 (modulus 8).

5. The printer of claim 1 wherein a number of pels in the index to the array is generally determined according to the following equation:
a mathematical floor operator of(a number of bits in the array index/the first number of bits per pel), wherein the number of bits in the array index is:
greater than or equal to the first number of bits per pel, and
divisible by 8.

6. The printer of claim 5 wherein a number of bytes of the output is generally determined according to the following equation:
(the number of pels in the index to the array*the second number of bits per pel)/8,
wherein the second number of bits per pel is >=8 and the second number of bits per pel≡0 (modulus 8).

7. A method comprising:
receiving a print datastream, wherein the print datastream includes bitmap data having a first number of bits per pel;
retrieving an array of conversion values used to convert the bitmap data to a second number of bits per pel;
converting the bitmap data to the second number of bits per pel using the array, wherein one or more bytes of the bitmap data is used as an index to the array to generate output data; and
generating a printed output based on the output data.

8. The method of claim 7 wherein a number of bytes of the index to the array is generally determined according to the following equation:
a mathematical ceiling operator of(the first number of bits per pel/8).

9. The method of claim 8 wherein a number of pels in the index to the array is generally determined according to the following equation:
((a number of bytes of the index to the array*8)/the first number of bits per pel).

10. The method of claim 9 wherein a number of bytes of the output is generally determined according to the following equation:
(the number of pels in the index to the array*the second number of bits per pel)/8,
wherein the second number of bits per pel is >=8 and the second number of bits per pel≡0 (modulus 8).

11. The method of claim 7 wherein a number of pels in the index to the array is generally determined according to the following equation:
a mathematical floor operator of(a number of bits in the array index/the first number of bits per pel), wherein the number of bits in the array index is:
greater than or equal to the first number of bits per pel, and
divisible by 8.

12. The method of claim 11 wherein a number of bytes of the output is generally determined according to the following equation:
(the number of pels in the index to the array*the second number of bits per pel)/8,
wherein the second number of bits per pel is >=8 and the second number of bits per pel≡0 (modulus 8).

13. A computer readable medium tangibly embodying programmed instructions which, when executed by a computing system are operable to perform a method, the method comprising:
receiving a print datastream, wherein the print datastream includes bitmap data having a first number of bits per pel;
retrieving an array of conversion values used to convert the bitmap data to a second number of bits per pel;
converting the bitmap data to the second number of bits per pel using the array, wherein one or more bytes of the bitmap data is used as an index to the array to generate output data; and
generating a printed output based on the output data.

14. The computer readable medium of claim 13 wherein a number of bytes of the index to the array is generally determined according to the following equation:
a mathematical ceiling operator of: (the first number of bits per pel/8).

15. The computer readable medium of claim 14 wherein a number of pels in the index to the array is generally determined according to the following equation:
((a number of bytes of the index to the array*8)/the first number of bits per pel).

16. The computer readable medium of claim 15 wherein a number of bytes of the output is generally determined according to the following equation:
(the number of pels in the index to the array*the second number of bits per pel)/8,
where the second number of bits per pel is >=8 and the second number of bits per pel≡0 (modulus 8).

17. The computer readable medium of claim 13 wherein a number of pels in the index to the array is generally determined according to the following equation:
a mathematical floor operator of(a number of bits in the array index/the first number of bits per pel), wherein the number of bits in the array index is:
greater than or equal to the first number of bits per pel, and
divisible by 8.

18. The computer readable medium of claim 17 wherein a number of bytes of the output is generally determined according to the following equation:
(the number of pels in the index to the array*the second number of bits per pel)/8,
wherein the second number of bits per pel is >=8 and the second number of bits per pel≡0 (modulus 8).
